(19) United States
(12) Patent Application Publication
(10) Pub. No.: US 2004/0058763 A1
(43) Pub. Date: Mar. 25, 2004

(54) Sandwich-molded guide for transmission device

(76) Inventor: Masahiko Konno, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/648,157

(22) Filed: Aug. 26, 2003

(30) Foreign Application Priority Data
Sep. 24, 2002 (JP) 2002-277405

(51) Int. Cl. F16H 7/08

(52) U.S. Cl. 474/111; 474/140

(57) ABSTRACT

In a sandwich molded guide for an endless, flexible, transmission medium such as a silent chain or roller chain, a slide rail and a rail support are sandwich-molded. The slide rail and the rail support are integrally molded from a high strength first polymer resin and the entire outer surface of the integrally molded structure is covered with a wear-resistant second polymer resin. A lightweight and inexpensive sandwich-molded guide, having excellent mechanical strength and wear resistance, can be easily molded in a single mold in a short molding cycle time, and can be readily recycled.

### FIELD OF THE INVENTION

This invention relates to guides for endless, flexible power transmission media, such as silent chains, roller chains and the like, used for a transmission of power between a driving sprocket and one or more driven sprockets, for example in the valve timing apparatus of an automobile engine. The invention relates more specifically to a plastic guide on which the transmission medium slides. The guide may be a fixed guide, or a movable guide for controlling tension in the transmission medium.

### BACKGROUND OF THE INVENTION

In an automobile engine or the like, a guide for a transmission medium, whether it be a movable guide or a fixed guide, is generally mounted on an engine block or other frame by one or more mounting bolts or pins. A movable guide may serve as a tensioner lever to apply proper tension to the transmission medium in order to prevent transmission failure due to excess tensioning or excess loosening of the circulating transmission medium. A fixed guide, such as a guide rail or the like, maintains the transmission medium in a required traveling path to prevent vibration noise, axial run-out, and disengagement, of the circulating transmission medium from its sprockets.

A conventional plastic guide 100, shown in FIGS. 6 to 8, which in this case is a tensioner lever, is molded from a single synthetic resin. The guide 100 comprises a slide rail body 101, on the front side of which a traveling transmission chain C slides, and a rail supporting body 102, arranged on the back side, and extending along the longitudinal direction of the slide rail body 101. The rail supporting body 102 is provided with a boss 102a, having a mounting hole 103 for pivotally receiving a mounting pin or bolt secured to an engine block or other suitable frame. The rail supporting body 102 also has a tensioner contact portion 102b for contacting the plunger of a tensioner (not shown). The plunger controls the pivoting position of the lever, thereby applying proper tension to the circulating transmission chain and preventing transmission failure due to excess tensioning or excess loosening of the chain. Ribs 102c, shown in FIG. 6, reinforce the guide while serving a weight-reducing function.

Since the conventional plastic guide 100 is integrally molded from a single synthetic resin, it was not possible to maintain the sliding contact properties and wear resistance required for a slide rail body 101 compatibly with strength required for the rail support body 101, especially in the high temperature environment of an automobile engine, which is typically around 150EC. For example, when the plastic guide 100 is molded from a plastics material having superior sliding contact properties and wear resistance, the guide has poor mechanical strength. However, when the cross-section dimensions are increased to compensate for the inadequate strength of the selected material, the thickness of the guide is increased, and the space taken up by the guide, when mounted on an engine block, is also increased.

To address the foregoing problem, it has been proposed to provide a slide rail which includes a support composed of a high strength synthetic resin, and a slide liner connected to the support and composed of a wear-resistant synthetic resin. Either the support or the slide liner is molded, and then used as a mold for injection molding of the other by use of the one as a mold, as described in Japanese patent publication No. 2818795 (pages 3 and 4, and FIG. 2). Alternatively, a chain tensioner in which a steel sheet or the like is insert-molded as a core material has been proposed in Japanese laid-open patent publication No. Hei. 8-254253 (page 2, FIG. 3). Another proposal, as described in Japanese laid-open patent publication No. Hei. 9-324839 (page 3-4, FIG. 2), is to provide a guide rail in which a smooth path liner is fitted and locked to a carrier by friction.

In the two-step molding process used to produce the slide rail disclosed in Japanese patent publication No. 2818795, the molding cycle time is long. Another problems is that, even if a dovetail groove is adopted to integrate both synthetic resins, the strength of the joint between the resins is weak. Still another problem is that the structure of the mold is complicated, thereby increasing manufacturing costs.

In the chain tensioner disclosed in Japanese laid-open patent publication No. Hei. 8-254253, the difference between coefficients of thermal expansion of the steel sheet core material and the plastics material can cause the guide to deform and break. Moreover, the use of a steel core increases the weight of the guide. In addition, disassembly of an insert-molded guide, and recycling of the molded product are difficult.

In the guide rail disclosed in Japanese laid-open patent publication No. Hei. 9-324839, in which a previously manufactured smooth liner is fitted to a carrier by friction, the manufacturing steps are complicated, and disadvantageous because they increase manufacturing cost. Further, the guide is subject to breakage, and not satisfactory from the standpoints of reliability and mechanical strength.

Accordingly, the objects of the invention are to solve the above-mentioned problems encountered in prior art plastic guides, and to provide a lightweight and inexpensive sandwich-molded guide for a transmission medium, which has superior mechanical strength and wear resistance, which can be easily molded using a single mold, which can be produced in a short molding cycle, and which can be readily recycled.

### SUMMARY OF THE INVENTION

To address the foregoing objects and the above-described problems, the sandwich-molded guide in accordance with the invention comprises an elongated slide rail having a surface along which an endless, flexible, transmission medium can travel in sliding contact along the direction of elongation, and an elongated rail support, extending along the direction of elongation of the slide rail, for supporting the slide rail. The slide rail and rail support are sandwich-molded to form a guide for guiding or maintaining tension in a transmission medium. The slide rail and rail support are integrally molded from a high strength first polymer resin material, the integrally molded slide rail and rail support have an outer surface entirely covered by a wear-resistant second polymer resin material.

The first polymer resin is preferably a polyamide 46 resin, an aromatic polyamide resin, or a glass fiber-reinforced polyamide 66 resin.

The second polymer resin is preferably a polyamide 66 resin or a polyamide 6 resin.

The term “sandwich molding” as used herein refers to a method of producing a molded product consisting of two kinds of polymer resin materials formed by simultaneously or substantially simultaneously injection-molding two kinds of melted polymer resin materials into a mold corresponding to the outer shape of the molded product, so that the product is a so-called skin-core, two-layer, molded product. The sandwich molding method in the invention can be carried out using a known sandwich molding injection-molding machine.

Known sandwich molding injection-molding machines are provided with various sandwich nozzles. In the case of a sandwich molding injection-molding machine provided with a parallel type sandwich nozzle, a torpedo (that is a switching member for switching between injection of a skin polymer resin material and injection of a core polymer resin material) is moved forward or backward so that the rate of injection quantity and injection speed can be finely controlled for both resins in accordance with the shape of the molded product. For example, in controlling the thickness of a skin layer in the invention, when a high-strength guide is to be molded, strength can be improved by decreasing the thickness of the skin layer and increasing the volume of the core layer.

Various resins may be used as the first and second polymer resins, but it is preferable that they have chemical affinity and that there be no large difference between their shrink characteristics, so that they become strongly fused to each other at their boundary during sandwich molding.

Since the slide rail and the rail support are integrally joined to each other in a fully fused condition, the sandwich molded guide in accordance with the invention exhibits durability superior to that of a conventional guide consisting of a single material or a guide composed of mechanically joined members, and can guide and/or maintain proper tension in a chain or other traveling transmission medium over a long period of time.

The second polymer resin, which covers the entire outer surface of the slide rail and rail support of the sandwich molded guide, exhibits excellent wear resistance, and can remain in sliding contact with a traveling transmission medium over a long period of time. Additionally, the slide rail and the rail support are reinforced by the skin composed of the second polymer resin material. Therefore, the sandwich molded guide exhibits superior durability.

### BRIEF DESCRIPTION OF THE DRAWINGS

FIG. 1 is a view for explaining a use embodiment of the present example;

FIG. 2 is a perspective view of a sandwich molded guide for a transmission device, which is an example of the invention;

FIG. 3 is a cross-sectional view taken on the plane 3-3 in FIG. 2;

FIG. 4 is a cross-sectional view taken on the plane 4-4 in FIG. 2;

FIG. 5 is a cross-sectional view taken on the plane 5-5 in FIG. 2;

FIG. 6 is a front view of a conventional movable guide;

FIG. 7 is a cross-sectional view taken on the surface 7-7 in FIG. 6; and

FIG. 8 is a cross-sectional view taken on the plane 8-8 in FIG. 6.

### DETAILED DESCRIPTION OF THE PREFERRED EMBODIMENTS

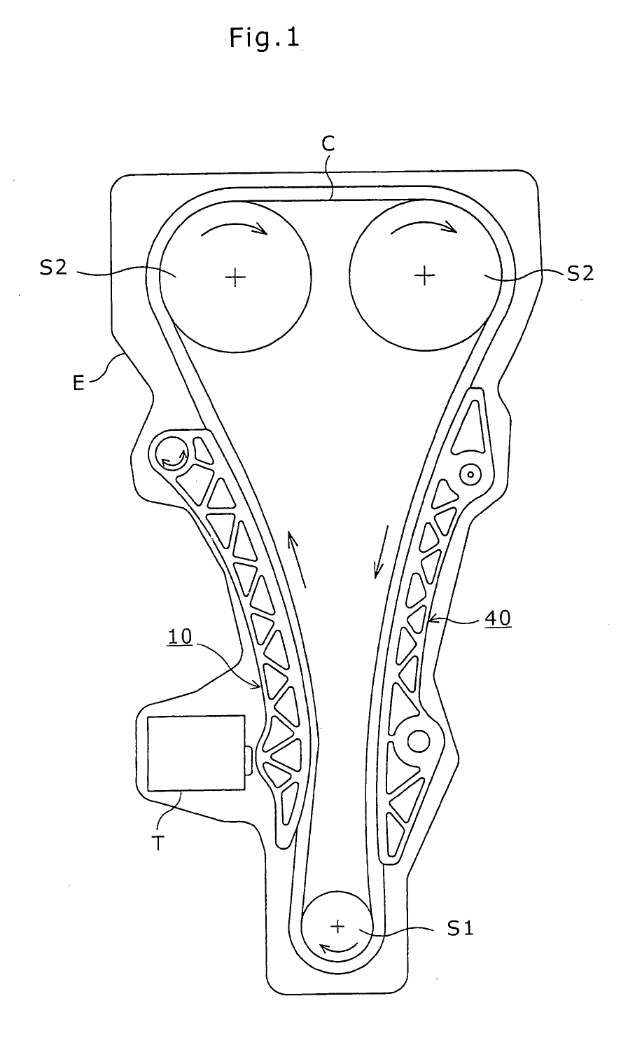

As shown in FIG. 1, a sandwich molded guide 10 is used in conjunction with a circulating transmission chain C, which is in driving engagement with a driving sprocket S1 and a pair of driven sprockets S2. The guide 10, which in this case is used as a movable guide, is in sliding contact with, and maintains tension in, the transmission chain C.

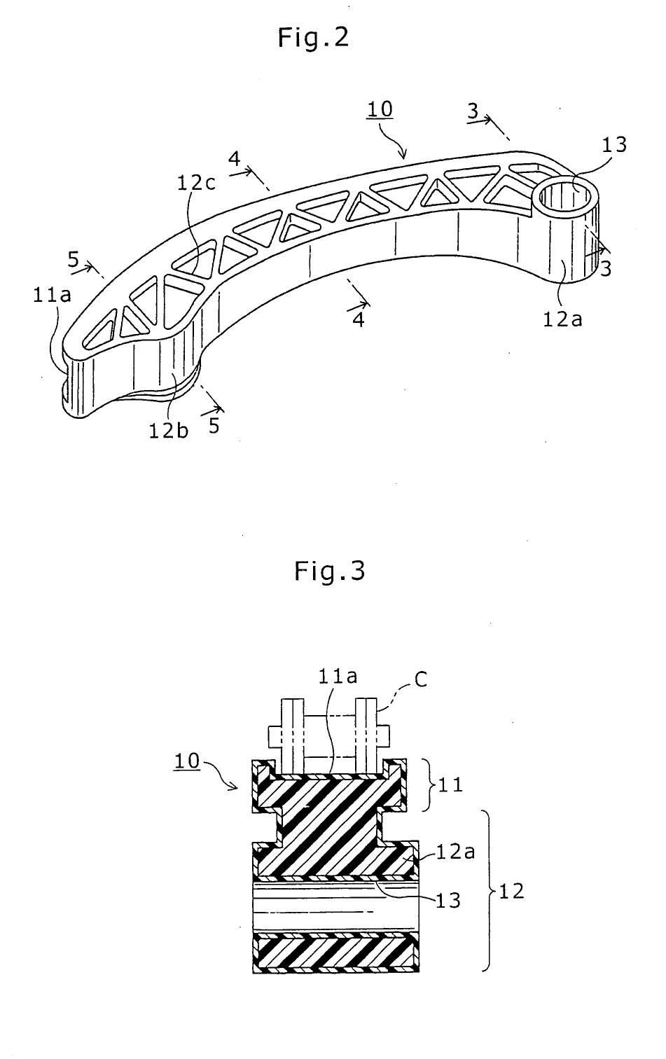

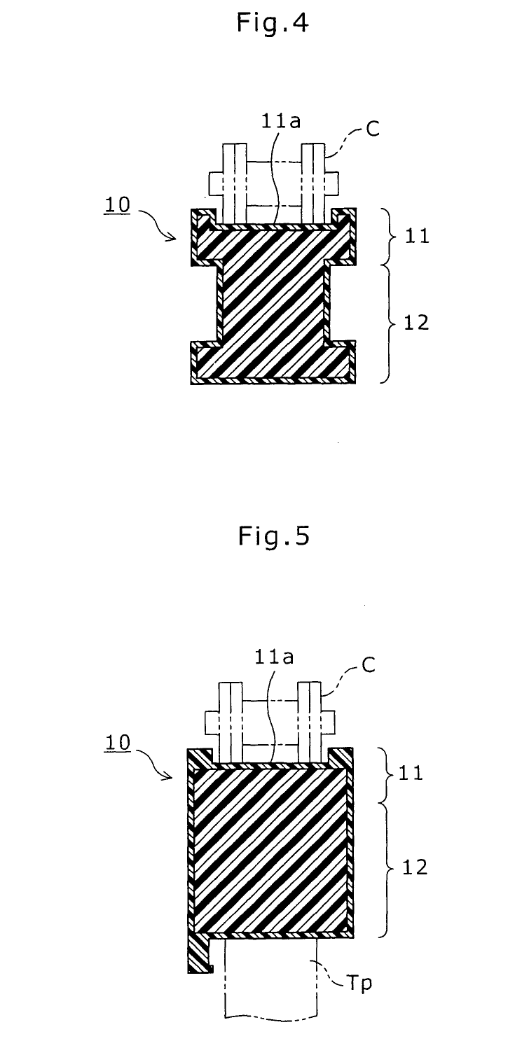

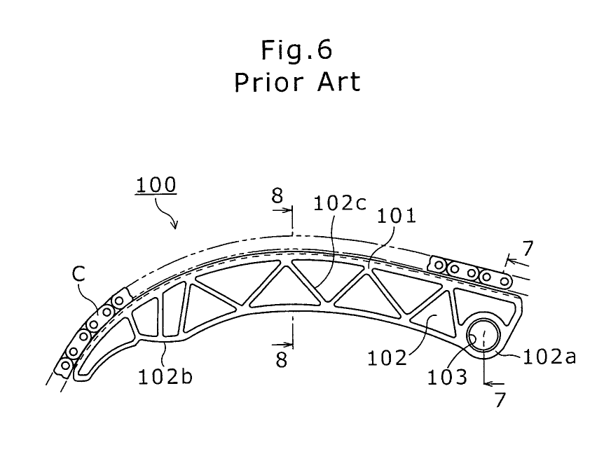

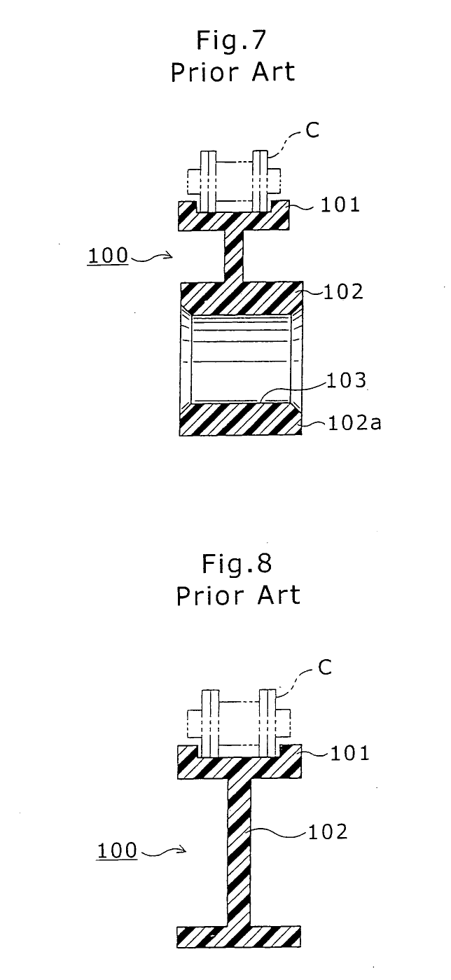

As shown in FIGS. 2 and 3, the sandwich molded guide 10 comprises a rail 11 including an arc-shaped sliding contact surface 11a extending along the traveling direction of a circulating transmission chain, and a rail support 12 extending longitudinally along the side of the rail 11 opposite to surface 11a. The rail support is provided with a boss 12a, having a mounting hole 14 for pivotal mounting of the guide on an engine block so that it functions as a movable guide. A tensioner contact portion 12b is provided for contacting a tensioner (not shown). The tensioner applies proper tension to the chain to prevent transmission failure due to excess tensioning or excess loosening of the chain. Reinforcing ribs 12c serve a reinforcing function and contribute to weight reduction.

A high strength polymer resin material, composed of a glass fiber-reinforced polyamide 66 resin, forms the core layers of the slide rail 11 and the rail support 12. Both members are fully and integrally fused together so that the strength required in the high temperature environment within an automobile engine can be maintained at a high level for a long period of time.

Any polyamide resin, such as polyamide 46 resin, aromatic polyamide resin or the like, or glass-reinforced polyamide 66 resin, which can exhibit high strength over a long period of time, can be used as the first polymer resin. Glass fiber-reinforced polyamide 66 resin is the most suitable for use as the first polymer resin.

A wear resistant second polymer resin material, composed of a polyamide 66 resin, may be adopted as the outer layer of the integrated core layers of the slide rail portion 11 and the rail supporting portion 12. This second polymer resin material is highly wear-resistant, and is maintained in sliding contact with the transmission chain C over a long period of time. In addition, the second polymer resin reinforces the strength of the slide rail 11 and the rail support 12.

Any polyamide resin which can exhibit wear resistance while in sliding contact with the transmission chain C over a long period of time may be used as the second polymer resin. Polyamide 66 is a preferred example of a suitable resin for use as the second polymer resin. Polyamide 46 is another example of a suitable polyamide resin. On the other hand, glass-reinforced polyamide 66 resin is not suitable for use as the second polymer resin.

Preferably the wear resistance of the second polymer is greater than that of the first polymer, and the strength of the first polymer is greater than that of the second polymer.

The guide structure is produced by sandwich molding as follows. A polyamide 66 resin is first injected, from the sandwich nozzle of a sandwich molding injection molding machine, into a single and simple mold corresponding to the outer shape of the molded guide to be produced. This starts the molding of the wear-resistant skin layer, which is formed from a second, wear-resistant, polymer resin over the entire outer shape of the slide rail 11 and the rail support 12. At the same time, or substantially at the same time as the start of injection of the skin layer consisting of a polyamide 66 resin, a glass fiber-reinforced polyamide 66 resin is injected to form the slide rail 11 and the rail support 12 as a core layer of high strength polymer resin material. After the mold is cooled, the molded guide is removed from the mold, thereby completing a molding cycle.

In the sandwich-molded guide 10, since the integrally formed slide rail 11 and rail support 12 is entirely covered with an outer layer of polyamide 66 resin, the slide rail 11 and the rail support 12 are more strongly joined to each other. Moreover, the surface layer portions of the boss 12a and the mounting hole 13, provided at one end of the rail support 12 for mounting the movable guide 10, are injection-molded with a polyamide 66 resin. Accordingly, the sandwich molded guide 10 can function smoothly, over a long period of time, as a pivotally movable guide which maintains proper tension by preventing excessive tensioning or loosening of a circulating transmission chain C.

Furthermore, since the entire sandwich molded guide 10 consists of a polymer resin, a significant weight reduction is achieved, and the molded guide can be easily recycled, without disassembly and separation of its components, after removal from the transmission.

The molding of the slide rail the molding of the rail support and an integration of the slide rail and the rail support can be carried out simultaneously or substantially simultaneously in a single, simple mold and in a single step. Thus, the sandwich-molded guide in accordance with the invention does not require a conventional special mold, and complicated manufacturing steps. The molding cycle time and manufacturing costs are significantly reduced. Furthermore, since the sandwich-molded guide does not require a steel sheet or the like as a core material, the weight of the guide is substantially reduced, and the molded guide of the invention can contribute to a reduction in fuel cost, and a reduction in vibration noise by suppression of vibration energy. Additionally, since the entire sandwich-molded guide consists of polymer resins, they need not be disassembled or separated after their removal from the transmission device, and recycling is thereby facilitated.

Since two kinds of fused polymer resins are simultaneously or substantially simultaneously injected and integrally joined with each other in a fully fused condition, high strength properties of the first polymer resin and the wear resistance of the second polymer resin can complement each other. The first polymer resin and the second polymer resin can be selected, taking into account the relationships between their wear resistance and high strength properties, and the high temperature environmental conditions to be encountered in an automobile engine or the like.

Since the outer surface of the slide rail and the rail support, which are integrally molded from a high strength first polymer resin, is entirely covered by a wear-resistant second polymer resin, the strength of the slide rail and the rail support is reinforced by the skin of second polymer resin, and the sandwich-molded guide of the invention exhibits excellent durability. Therefore, the wear resistance required for the slide rail, and the strength required for the rail support portion, can be compatibly maintained at a high level over a long period of time under high temperature environment such as found inside an automobile engine.

Additionally, the surface layer of the boss and mounting hole, provided at one end of the rail support for mounting the movable guide, are injection-molded from a second polymer resin material having wear resistance. Accordingly, the sandwich-molded guide can function smoothly over a long period of time as a pivotally movable guide to maintain proper tension in a chain or other transmission medium.

I claim:

1. A sandwich-molded guide for an endless, flexible, transmission medium, said guide comprising an elongated slide rail having a surface along which said transmission medium can travel in sliding contact along the direction of elongation, and an elongated rail support, extending along said direction of elongation, for supporting said slide rail, the slide rail and rail support being sandwich-molded to form a guide for guiding or maintaining tension in said transmission medium, wherein said slide rail and said rail support are integrally molded from a high strength first polymer resin material, the integrally molded slide rail and rail support have an outer surface, and said outer surface is entirely covered by a wear-resistant second polymer resin material.

2. A sandwich-molded guide for an endless, flexible, transmission medium according to claim 1, wherein said first polymer resin material is a glass fiber reinforced polyamide 66 resin.

3. A sandwich-molded guide for an endless, flexible, transmission medium according to claim 1, wherein said first polymer resin material is a polyamide 46 resin.

4. A sandwich-molded guide for an endless, flexible, transmission medium according to claim 1, wherein said first polymer resin material is an aromatic polyamide resin.

5. A sandwich-molded guide for an endless, flexible, transmission medium according to claim 1, wherein said second polymer resin material is a polyamide 66 resin.

6. A sandwich-molded guide for an endless, flexible, transmission medium according to claim 2, wherein said second polymer resin material is a polyamide 66 resin.

7. A sandwich-molded guide for an endless, flexible, transmission medium according to claim 3, wherein said second polymer resin material is a polyamide 66 resin.

8. A sandwich-molded guide for an endless, flexible, transmission medium according to claim 4, wherein said second polymer resin material is a polyamide 66 resin.

9. A sandwich-molded guide for an endless, flexible, transmission medium according to claim 1, wherein said second polymer resin material is a polyamide 6 resin.

10. A sandwich-molded guide for an endless, flexible, transmission medium according to claim 2, wherein said second polymer resin material is a polyamide 6 resin.

11. A sandwich-molded guide for an endless, flexible, transmission medium according to claim 3, wherein said second polymer resin material is a polyamide 6 resin.

12. A sandwich-molded guide for an endless, flexible, transmission medium according to claim 4, wherein said second polymer resin material is a polyamide 6 resin.
